(19) United States
(12) Patent Application Publication
(10) Pub. No.: US 2009/0294721 A1
(43) Pub. Date: Dec. 3, 2009

(54) Valve assembly for a container with an inner bag for receiving beverage

(76) Inventors: Albert Wauters, Destelbergen (BE); Ian Anderson, Cambridge (GB)

Correspondence Address: Paul Grandinetti;Levy & Grandinetti, P.O. Box 18385, Washington, DC, 20036-1419, US

(21) Appl. No.: 11/597,100

(22) PCT Filed: May 19, 2005
(86) PCT No.: PCT/IB05/01361

§ 371 Date: Aug. 6, 2009

(30) Foreign Application Priority Data
May 19, 2004 (GB) 04111171.2

(51) Int. Cl. F16K 27/00

(52) U.S. Cl. 251/366

(57) ABSTRACT

The present relates to a beverage valve assembly (5) comprising:—a bottom wall section (12);—a tubular part (14) extending downward from the bottom wall section;—an outer apron (9) standing up from the bottom wall section (12); wherein the tubular part (14) has a top opening (21) to receive a dispensing element (3), whereby the top opening (21) is preferably arranged in the middle section of the upper outer surface of the bottom wall (12), and the tubular part (14) has an upper inner tubular wall section with at least one sealing surface (15,16), the outer standing up apron (9) is arranged at a distance from the top opening (21) of the tubular part (14), whereby the bottom wall (12) section comprises at least one valve positioned between the top opening (21) of the tubular part (14) and an inner side wall section of the outer standing up apron (9).

### FIELD OF THE INVENTION

The present relates to a beverage valve assembly and a beverage valve assembly arranged at a container with an inner bag for receiving beverage, in particular carbonated beverage such as beer. Further, the present invention is directed to a connecting element for engaging to a beverage valve assembly. The present invention is further directed to a tapping device comprising a connecting element. The present invention is also directed to a beverage tapping apparatus comprising a replaceable container with a beverage valve assembly receivable engaged to a connecting element of a tapping device as well as to method for dispensing beer from a beverage tapping apparatus.

### BACKGROUND OF THE INVENTION

A valve assembly for use in beverage containers with an inner bag for receiving beverage is described in WO-A1 03/050031. In WO-A1 03/050031 a valve assembly is described of a container in which an inner bag is provided for receiving beverage, in particular carbonated beverage such as beer, wherein a beverage valve is provided which on the side facing the inner bag is provided with a communication with the inner space of the bag and on the opposite side is provided with means for operation of the beverage valve by a tapping device in which the container is receivable, wherein the beverage valve, on the opposite side, is surrounded by a standing up first apron which is gas-tight, while along the outer side of said first apron, at a distance there from, a second apron is arranged, also gas-tight, while between the first and the second apron a bottom wall with at least one gas passage opening is provided which during operation is in communication with the space enclosed between the inner bag and a container surrounding the inner bag, the arrangement being such that during operation a collar of a connecting element abuts gas-tightly and liquid-tightly against the second apron, while a dispensing element abuts gas-tightly and liquid-tightly against the first apron, so that between the two aprons a chamber is formed through which gas under pressure can be forced through said at least one gas passage opening, separately from the beverage.

However, the valve assembly of WO-A1 03/050031 suffers from that the first apron as well as the second apron are standing up, thus can be damaged if the connecting element is displaced when the parts are fused together, so that during operation the collar of said connecting element does not abuts gas-tightly and liquid-tightly against the second apron. Bearing in mind that the aprons are fragile, a displacement at fusion can easily causes a twist or even are break of the first and/or the second apron associate with a leakage. Further, the dispensing element abuts gas-tightly and liquid-tightly against the first apron only, so that a damaged as described above leads to gas and liquid leakage. Furthermore, gas-tightly and liquid-tightly sealing is provided only for the first apron to the dispensing element and of the second apron to the collar of the connecting element. Therefore, a leakage of at least one apron only leads to a malfunction of the entire valve assembly. Moreover, if the dispensing element is not in place a gas and liquid leakage occurs at the first apron associated with a gas and liquid leakage of the chamber formed between the first and second apron.

### SUMMARY OF THE INVENTION

The object of the invention is to provide a valve assembly, in which at least most of the disadvantages mentioned have been avoided. More particular, the object of the invention is to provide a valve assembly for containers with inner bag, permitting a gas-tightly and liquid-tightly safe positioning of a connecting dispensing element to a beverage valve arrangement.

A first object of the invention is to provide a beverage valve assembly, in which at least most of the disadvantages mentioned have been avoided.

This object is solved by a beverage valve assembly, comprising:
a bottom wall section;
a tubular part extending downward from the bottom wall section;
an outer apron standing up from the bottom wall section;
   wherein the tubular part has a top opening to receive a dispensing element, whereby the top opening is arranged preferably in the middle section of the upper outer surface of the bottom wall, and the tubular part has an upper inner tubular wall section with at least one sealing surface, the outer standing up apron is arranged at a distance from the top opening of the tubular part, whereby the bottom wall section comprises at least one valve positioned between the top opening of the tubular part and an inner side wall section of the outer standing up apron.

The outer standing up apron can serve during operation to abut gas-tightly and liquid-tightly against a first collar of a connecting element. Preferably, a first collar of a connecting element can abut gas-tightly and/or liquid-tightly against the first sealing surface of the inner side of said apron.

Further, the tubular part of the beverage valve assembly, preferably inside with a step-like and/or shoulder-like form, has an upper inner tubular wall section with at least two sealing surfaces. These structural measurements of the special designed sealing surface/s arranged at the upper inner tubular wall section provides that a second collar of a connecting element can abut gas-tightly and/or liquid-tightly against the second sealing surface of the inner tubular part, while a dispensing element can abut gas-tightly and liquid-tightly against the third sealing surface of the inner tubular part.

The beverage valve assembly according to the present invention has the advantage that even a displacement of the connecting element to the beverage valve assembly can not damage a sealing component, thus a displacement does not lead to gas and liquid leakage. Furthermore, a gas-tightly and liquid-tightly sealing is provided inside the inner tubular wall section by at least said second collar of the connecting element which abuts gas-tightly and/or liquid-tightly against the second sealing surface of the inner tubular part and said dispensing element which abuts gas-tightly and liquid-tightly against the third sealing surface of the inner tubular part.

Therefore, even a leakage at the second sealing surface or at the third sealing surface does not lead to a malfunction of the entire valve assembly, so that gas and beverage are not contaminated by each other at the inner tubular part. Moreover, if the dispensing element is not in place a gas leakage can not occur at the inner tubular part, because the second collar of the connecting element abuts gas-tightly and liquid-tightly against the second sealing surface of the inner tubular part separate from the dispensing element.

The following description of the present invention makes clear that the valve assembly according to the present invention can provide a releasable connection of the connecting dispensing element to the beverage valve arrangement.

Further, the valve assembly according to the present invention can provide a gas-tightly and liquid-tightly sealing of the connecting dispensing element to the beverage valve arrangement simultaneously in order to provide at the same time a separate gas passage and beverage passage.

Further, the valve assembly according to the present invention can provide a gas-tightly and liquid-tightly sealing of the connecting dispensing element to the beverage valve arrangement, whereby the beverage passage is sealed gas-tightly and liquid-tightly with respect to the gas chamber before the chamber of the gas passage is gas-tightly and liquid-tightly sealed.

Further, the valve assembly according to the present invention can provide that the air- or CO₂-valve is not accidentally pushed open during the operation if the seals of a connected dispensing element to the beverage valve arrangement are displaced.

The beverage valve assembly according to the present invention can comprise at least one positioning means. At least one positioning means can be arranged along the inner side wall section of said apron and at a distance there from, whereby at least one positioning means is preferably a standing up wall, more preferably at least one positioning means is a standing up wall surrounding the top opening of the tubular part. Most preferably at least one positioning means has an annular shape or the form of a ring.

It is possible that the beverage valve assembly of the present invention has at least two, three or more positioning means.

At least one positioning means is used to secure that the connecting element can not be displaced, thus the positioning serves as a guiding means. Further, at least one positioning means is used to secure that the tubular dispensing element of a beverage dispensing system engages into the tubular part of the beverage valve assembly, thus can not be displaced.

At least one positioning means can be designed so that it abuts gas-tightly and liquid-tightly against the connecting element when the connecting element is arranged proper on the beverage valve assembly. For example, at least one positioning means can comprise at least one flexible sealing means. However, it is most preferred that the at least one positioning means does not have a sealing function but a guiding function to secure that the connecting element proper fits to the beverage valve assembly at the time of connection and use.

At least one positioning means of the beverage valve assembly can engage into the recess formed between the first and second collar of the connecting element. The thickness and width of at least one positioning means is chosen so that it fits into the recess of said connecting element, when the beverage valve assembly and the connecting element are proper connected to each other. In case at least one positioning means has a sealing function it is designed so that it abuts gas-tightly and liquid-tightly against at least a side wall of a first and/or second collar and/or against the bottom of the recess of the connecting element.

However, it is most preferred as already mentioned above that at least one positioning means does no abuts gas-tightly and liquid-tightly against at least a side wall of a first and/or second collar and/or against the bottom of the recess of the connecting element. Furthermore, it is preferred that, if the beverage valve assembly and the connecting element is connected to each other for use, at least one positioning means does not contacts against at least a side wall section of the first collar, against at least a side wall section of the second collar and/or against at least a bottom wall section of the recess of the connecting element.

Further, it is preferred that the at least one positioning means does not have a hole or opening.

The beverage valve assembly according to the present invention is now described in more detail.

The beverage valve assembly according to the present invention comprises at least one apron, whereby one apron only is most preferred. The inner side wall section of the apron serves as a first sealing surface so that a connecting element is able to abut gas-tightly and liquid-tightly against the first sealing surface of the inner side wall section of said apron. The use of one apron only, in particular if the apron is arranged near to or at the outer edge of the beverage valve assembly the danger of a demolition, a twist or even a crack which leads to a malfunction during use can be significant reduced or avoided.

It is preferred that the apron is concentrically arranged so that a collar of the connecting element can internally engage. However, it can be possible that the collar, preferably the first collar comprises a recess, so that the apron engages and abut gas-tightly and liquid-tightly against the recess of the first collar. Nevertheless, a construction is preferred wherein the inner side wall section of the apron of the beverage valve assembly functions as a first sealing surface so that an outer sidewall of a connecting element is able to abut gas-tightly and liquid-tightly against the first sealing surface of the inner side wall section of said apron.

The apron and at least one positioning means of the beverage valve assembly according to the present invention is preferably arranged concentrically with respect to the top opening. A concentrically arrangement provides among other advantages a better gas-tightly and liquid-tightly sealing of the apron of the beverage valve assembly against the first collar of the connecting element. Further a concentrically arrangement of at least one positioning means allows an improved assembling of the beverage valve assembly with the connecting element as well as reduces or avoids the danger of a displacement associated with a leakage. Further, a concentrically arrangement of at least one positioning means can provide that the air-valve and/or CO₂-valve is not accidentally pushed open during the operation, because a displacement of the dispensing element is avoided.

The inner tubular part of the beverage valve assembly according to present invention comprises preferably at least one sealing surface and more preferred at least a first sealing surface and a second sealing surface. Said first sealing surface can be arranged equal, can be arranged above or can be arranged below to the upper outer surface of the bottom wall section of the beverage valve assembly.

Preferably, the sealing surface/s of the inner tubular wall section is annularly shaped. More preferred is that the first sealing surface is annularly shaped.

More preferred is, that the inner tubular wall section of said upper tubular part has at least two sealing surfaces, preferably the sealing surfaces are annularly shaped.

It is preferred that the diameter of the opening of the tubular within the annularly shaped first step or first shoulder is substantially larger than the diameter of the opening of the tubular part within the annularly shaped second step or second shoulder.

Inside the tubular part, preferably below the second step or second shoulder, a beverage valve can be arranged, for example to control the beverage flow.

Further, the bottom wall of the beverage valve assembly according to the present invention can comprise two valves, preferably one valve is connected to the passage to the space between the keg and the bag and one is connected to the passage to the inner part of the bag, more preferably the valve connected to the passage to the space between the keg and the bag is an air valve and/or the valve connected to the passage to the inner part of the bag is a CO₂-valve, preferably the valves are spaced radially out at the same circle-normal at an equal distance of each other from the center point and are arranged in the bottom wall section between the inner wall section of said outer apron and the opening of the tubular part or within the bottom wall section between the inner wall section of said outer apron and the outer wall section of said inner positioning means.

In the following data of specification is given for the beverage valve assembly according to the present invention. It is noted, that the actual dimension of the beverage valve assembly according to the present invention is selected such, that the beverage valve assembly fits to the connecting element as well as to dispensing element without a malfunction. Thus, data are selected from the ranges given below in such a way that a fitting into the other described parts such as connecting element, dispensing element etc. are assured without causing a malfunction.

The term “fits” as used in the present description means that the dimension of the parts is selected so, that during use a proper function is assured.

The internal diameter of the standing up apron can be 10 mm to 100 mm, preferably 20 mm to 60 mm and more preferably 30 mm to 50 mm; and the height of the apron measured from the upper outer surface of the bottom adjacent to the apron can be 0.5 mm to 50 mm, preferably 3 mm to 30 mm and more preferably 5 mm to 25 mm; and the thickness of the apron is 0.1 mm to 15 mm, preferably 0.5 mm to 10 mm and more preferably 1 mm to 5 mm.

The internal diameter of the standing up positioning means can be 0.5 mm to 50 mm, preferably 5 mm to 30 mm and more preferably 10 mm to 25 mm; and the height of at least one positioning means measured from the upper outer surface of the bottom adjacent to the apron can be 0.5 mm to 50 mm, preferably 3 mm to 30 mm and more preferably 5 mm to 25 mm; and the thickness of at least one positioning means can be 0.1 mm to 15 mm, preferably 0.5 mm to 10 mm and more preferably 1 mm to 5 mm.

The diameter of the top opening of the apron facing away from the bottom wall can be 0.5 mm to 50 mm, preferably 3 mm to 30 mm and more preferably 5 mm to 25 mm; and/or the diameter of the top opening of at least one positioning means facing away from the bottom wall can be 0.5 mm to 50 mm, preferably 3 mm to 30 mm and more preferably 5 mm to 25 mm.

The internal diameter of the top opening of the tubular part and/or the diameter of the opening within the annularly shaped first step or first shoulder of the tubular part can be 0.5 mm to 50 mm, preferably 3 mm to 30 mm and more preferably 5 mm to 25 mm; and/or the diameter of the opening within the annularly shaped second step or second shoulder of the tubular part can be 0.5 mm to 50 mm, preferably 3 mm to 30 mm and more preferably 5 mm to 25 mm.

The width of the upper outer surface of the annularly formed first step or first shoulder can be 0.5 mm to 50 mm, preferably 3 mm to 30 mm and more preferably 5 mm to 25 mm; and/or the width of the upper outer surface of the annularly formed second step or second shoulder can be 0.5 mm to 50 mm, preferably 3 mm to 30 mm and more preferably 5 mm to 25 mm.

The altitude difference between the upper outer surface of the annularly formed first step or first shoulder to the upper outer surface of the annularly formed second step or second shoulder can be 0.1 mm to 50 mm, preferably 1 mm to 25 mm and more preferably 2 mm to 20 mm.

A second object of the present invention is related to connecting element. In particular, it relates to a connecting element for engaging to a beverage valve assembly.

The connecting element is used for engaging to a beverage valve assembly in order to provide a separate gas and beverage passage. The connecting element can comprise a first outer collar and a second inner collar. The first and the second collar of the connecting element have preferably a circular form. It is preferred that the first outer collar has at least one gas passage opening and/or the second inner collar has a continuous opening for receiving a dispensing element. The first outer collar and/or the second inner collar can be arranged, preferably concentrically, at a distance from each other. Between the first outer collar and the second inner collar a recess, preferably concentrically arranged, can be formed.

A connecting element for engaging with a beverage valve assembly according to the present invention comprises preferably a first collar and a second collar, whereby between the first and the second collar a recess with a bottom wall is formed. The shape of the recess can have the form that at least one positioning means can engage into the recess, whereby the at least one positioning means does not contact the bottom wall and/or a side wall of the recess if it fits proper. However, the form of at least one positioning means can be designed in such a way, that at least one positioning means contacts the bottom wall and/or a side wall of the recess. However, it is most preferred that the recess does not abut gas-tightly and liquid-tightly against an outer side wall of at least one positioning means.

The second inner collar can be higher than the first outer collar. This has the advantage that the second inner collar can engage into the tubular part of the beverage valve assembly, whereby the second collar is preferably concentrically arranged.

More preferred, the height of the second inner collar is adjusted so, that it abut gas-tightly and/or liquid-tightly against the first sealing surface of the inner tubular part of the beverage valve assembly, when the connecting element and the beverage valve assembly is joint to replaceable to each other.

Most preferred is that the connecting element and the beverage valve assembly are removable joint.

The first collar and/or the second collar can have at least one hole for a gas passage. However, it is most preferred that the first outer collar has one continuous hole or also called “through going” hole only for a gas passage. To this gas passage air under pressure can be flow through. The first collar of the connecting element should be joint in such a way on the beverage valve assembly, that a gas passage from the through going hole of the first collar over the gas-valve to the passage to the space between the keg and the bag is formed.

The second collar has at least one continuous hole or also called “through going” hole to which the dispensing element is lead through. Preferably, the “through going” hole of the second collar is arranged in the center of the second collar.

Further, the second collar with a through going hole in the center can possess on its upper top section of the opening of said through going hole a step onto which the dispensing element can be hold.

The connecting element and the beverage valve assembly can be removable joint in such a way that during operation a first collar of the connecting element according to the present invention abuts gas-tightly and liquid-tightly against the first sealing surface of the inner side of the apron of the beverage valve assembly whereby a gas chamber can be formed and a second collar of said connecting element abuts gas-tightly and liquid-tightly against the second sealing surface of the tubular part of the beverage valve assembly. A gas chamber is formed, if the top of the surface of the first collar does not or at least partly contacts the bottom wall section between the apron and at least one positioning means or tubular of the beverage valve assembly. In the case where a gas chamber is formed, the second collar which abuts gas-tightly and liquid-tightly against the second sealing surface of the tubular part can also seal the gas chamber.

The second inner collar provides a “through going” hole for receiving a dispensing element. The through going hole of the second inner collar of the connecting element is preferably arranged in the center of the second collar. While a dispensing element abuts gas-tightly and liquid-tightly against the third sealing surface of the inner tubular part, the connecting element is positioned so that the gas passage opening of the first collar is in communication with the gas valve, so that gas under pressure can be forced through said at least one gas passage opening, separately from the beverage.

Further the first outer collar of the connecting element according to the present invention can provide at its upper outer surface, preferably at or near to the outer edge of its upper outer surface, at least one flexible sealing means; and/or the second inner collar of the connecting element can provide at its upper outer surface, preferably at or near to the outer edge of its upper outer surface, at least one flexible sealing means.

The flexible sealing means can be an o-ring or any other flexible sealing material. Preferably the sealing material can be rubber, Teflon or there like.

In the following specification data are given for the connecting element according to the present invention. It is noted, that the actual dimension of the connecting element is adjusted in such a way, that the connecting element fits, most preferably replaceable fits, to the beverage valve assembly as well as to dispensing element at use without a malfunction. Thus, data are selected from the ranges given below in such a way that a fitting into the other described parts such as beverage valve assembly, dispensing element etc. are assured without causing a malfunction. With other words the ranges given below are selected so that the connecting element fits proper.

The internal diameter of the first outer collar can be 1 mm to 100 mm, preferably 20 mm to 60 mm and more preferably 30 mm to 50 mm; and the height of the first outer collar as measured from the bottom of the recess adjacent to the first outer collar can be 0 mm to 50 mm, preferably 5 mm to 30 mm and more preferably 10 mm to 25 mm; and the thickness of the first outer collar can be 0.1 mm to 30 mm, preferably 1 mm to 20 mm and more preferably 2 mm to 15 mm.

The internal diameter of the second inner collar can be 0.1 mm to 50 mm, preferably 2 mm to 35 mm and more preferably 5 mm to 25 mm; and the height of the second inner collar as measured from the bottom of the recess adjacent to the second inner collar can be 0 mm to 50 mm, preferably 2 mm to 40 mm and more preferably 5 mm to 30 mm; and the thickness of the second inner collar can be 0.1 mm to 15 mm, preferably 0.2 mm to 10 mm and more preferably 0.5 mm to 5 mm.

The internal diameter of the top opening of the first inner collar facing to the beverage valve assembly can be 0.1 mm to 50 mm, preferably 2 mm to 35 mm and more preferably 5 mm to 25 mm; and/or the internal diameter of the top opening of the through going hole of the second inner collar facing to the beverage valve assembly can be 0.1 mm to 50 mm, preferably 2 mm to 35 mm and more preferably 5 mm to 25 mm.

The distance of the inner side wall of the first collar to the outer side wall of the second collar can be 0.5 mm to 50 mm, preferably 2 mm to 20 mm and more preferably 5 mm to 15 mm.

A third object according to the present invention relates to a tapping device.

The tapping device comprises a connecting element according to the present invention. The tapping device according to the present invention is provided with means for operation of a beverage valve assembly to which a container is receivable engaged.

The second inner collar of the connecting element of said tapping device has a through going hole for receiving the tubular dispensing element. The tubular dispensing element can abut gas-tightly and liquid-tightly against the third sealing surface of the inner tubular part.

The tubular dispensing element can be a cartridge unit with an inner channel or pipe for the dispensation of a beverage. That cartridge unit can comprise preferably a first part facing to the container, which is made out of a rigid material and a second part faces in the opposite direction, which is made out of a flexible material.

The tubular dispensing element of the cartridge unit is higher than the second inner collar. Preferably the tubular dispensing element of the cartridge unit extends over the inner edge of the top opening of the second collar facing to the beverage valve assembly. The height of the tubular dispensing element can be ≧0 mm to 100 mm, preferably 5 mm to 60 mm and more preferably 20 mm to 50 mm.

A fourth object according to the present invention relates to a beverage valve assembly according to the present invention arranged at a container in which an inner bag is provided for receiving beverage, in particular carbonated beverage such as beer. The beverage valve assembly is arranged at said container, to which during operation a connecting element or a tapping device as already described can be arranged.

The beverage valve assembly according to the present invention is joint in such a way, that during operation a first collar of the connecting element abuts gas-tightly and liquid-tightly against the first sealing surface of the inner side of said apron, and/or a second collar of said connecting element abuts gas-tightly and liquid-tightly against the second sealing surface of the tubular part, and/or a dispensing element abuts gas-tightly and liquid-tightly against the third sealing surfaces of the inner tubular part. On the side facing the inner bag it is provided a gas passage opening to the inner space of the bag and on the opposite side is surrounded by an outer standing up apron which is gas-tight, while along the inner side wall of said apron, which functions as a first sealing surface and at a distance there from, an inner positioning means is arranged, while between said apron and said positioning means a bottom wall with at least one gas valve is provided which during operation is in communication with the space enclosed between the inner bag and the container surrounding the inner bag over a gas passage, a tubular part for receiving a dispensing element is arranged in the center, optionally surrounded by a standing up positioning means, whereby said inner tubular part comprises a second sealing surface and a third sealing surface, the valve assembly being such that during operation a first collar of a connecting element according to the present invention abuts gas-tightly and liquid-tightly against the first sealing surface of the inner side of said apron and a second collar of said connecting element abuts gas-tightly and liquid-tightly against the second sealing surface of the tubular part, while a dispensing element abuts gas-tightly and liquid-tightly against the third sealing surface of the inner tubular part, whereby the connecting element is positioned in such a way that the gas passage opening of the first collar is in communication with the gas valve, so that gas under pressure can be forced through said at least one gas passage opening, separately from the beverage. Further, said positioning means of the beverage valve assembly engages into a recess formed between the first and second collar of the connecting element.

A fifth object according to the present invention relates to a beverage tapping apparatus.

A general beverage tapping apparatus is described in WO-A1 03/050031 and is incorporated by reference.

The beverage tapping apparatus according to the present invention comprises a replaceable container with a beverage valve assembly according to the present invention receivable engaged to a connecting element of a tapping device according to the present invention, whereby the beverage valve assembly on the side facing the inner bag is provided with a gas passage opening to the inner space of the bag and on the opposite side is surrounded by an outer standing up apron which is gas-tight, while along the inner side wall of said apron, which functions as a first sealing surface and at a distance there from, an inner positioning means is arranged, while between said apron and said positioning means a bottom wall with at least one gas valve is provided which during operation is in communication with the space enclosed between the inner bag and the container surrounding the inner bag over a gas passage, a tubular part for receiving a dispensing element is arranged in the center, optionally surrounded by a standing up positioning means, said positioning means of the beverage valve assembly engages into a recess formed between the first collar and second collar of the connecting element, whereby said inner tubular part comprises a second sealing surface and a third sealing surface, the valve assembly being such that during operation a first collar of a connecting element according to the present invention abuts gas-tightly and liquid-tightly against the first sealing surface of the inner side of said apron and a second collar of said connecting element abuts gas-tightly and liquid-tightly against the second sealing surface of the tubular part, while a dispensing element abuts gas-tightly and liquid-tightly against the third sealing surface of the inner tubular part, whereby the connecting element is positioned so that the gas passage opening of the first collar is in communication with the gas valve, so that gas under pressure can be forced through said at least one gas passage opening, separately from the beverage.

The tapping apparatus can comprise pressure means and/or chiller means. It is preferred that the tapping device with the connecting element is arranged at the beverage valve assembly, which is arranged on the container with an inner bag containing the beverage, so that the tapping apparatus functions as a housing for replaceable receiving the tapping device with the connecting element arranged at the beverage valve assembly, which is arranged on the container with an inner bag containing the beverage.

Further advantageous embodiments of a beverage valve assembly, a connecting element, a tapping device and a beverage tapping apparatus according to the invention are further elucidated herein below with reference to the drawing. In the description of the drawing the first sealing surface is an inner wall section of the apron and the section and third sealing surfaces are an inner wall section of the tubular part of the beverage valve assembly. The same applies to the claims where first-, second- and third sealing surfaces are mentioned.

### DESCRIPTION OF THE DRAWINGS

FIG. 1 sectional side elevation of a beverage tapping apparatus according to the present invention

FIG. 2 cutout of the sectional side elevation of FIG. 1

FIG. 3 sectional side elevation of a beverage valve assembly according to the present invention arranged on a container

FIG. 4 a topside sectional side elevation of a beverage valve assembly according to the present invention

FIG. 5 sectional side elevation of a beverage valve assembly and a connecting element according to the present invention before joint

FIG. 6 sectional side elevation of a beverage valve assembly and a connecting element according to the present invention replaceable joint to each other

### DETAILED DESCRIPTION OF THE INVENTION

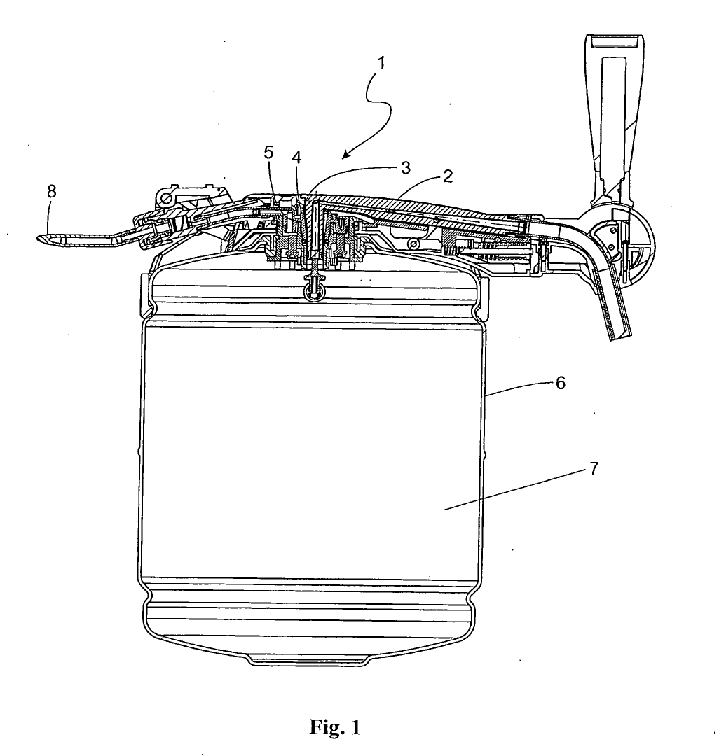

In the drawing FIG. 1 shows in sectional side elevation a beverage tapping apparatus (1) according to the present invention with a tapping device (2) and a dispensing element (3), whereby the tapping device with the connecting element (4) is replaceable joint to the beverage valve assembly (5) connected to a container (6) in which an inner bag (7) is provided for receiving beverage. The container can be placed on a chiller plate, not shown. Further, the tapping device can be connected to pressure means (8).

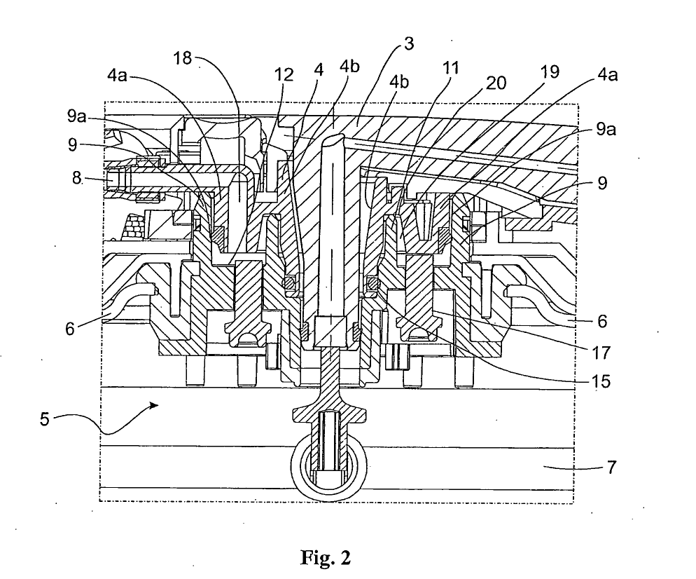

In the drawing FIG. 2 shows a cutout of the sectional side elevation of FIG. 1 in which the beverage valve assembly (5) according to the present invention is arranged on a container (6) in which an inner bag (7) is provided for receiving beverage, such as beer. The beverage valve assembly (5) is on the side facing the inner bag (7) provided with a gas passage opening (10) to the inner space of the bag (7) and on the opposite side is surrounded by an outer standing up apron (9) which is gas-tight, while along the inner side wall of said apron (9), which functions as a first sealing surface (9a) and at a distance there from, an inner circular positioning means (11) is arranged, while between said apron (9) and said positioning means (11) a bottom wall (12) with a gas valve (13) and a CO₂-valve (17) are arranged, the gas valve (13) is during operation in communication with the space enclosed between the inner bag (7) and the container (8) surrounding the inner bag over a gas passage (10), a tubular part (14) for receiving a dispensing element (3) is arranged in the center of the beverage valve assembly (5), surrounded by the standing up positioning means (13), whereby said inner tubular part (14) comprises a second sealing surface (15) and a third sealing surface (16). The valve assembly (5) being assembled such that during operation a first collar (4a) of a connecting element (4) abuts gas-tightly and liquid-tightly against the first sealing surface (9a) of the inner side of said apron (9) and a second collar (4b) of said connecting element (4) abuts gas-tightly and liquid-tightly against the second sealing surface (15) of the tubular part (14), while a dispensing element (3) abuts gas-tightly and liquid-tightly against the third sealing surface (6) of the inner tubular part (14), whereby the connecting element (4) is positioned in such a way that the gas passage opening (18) of the first collar (4a) is in communication with the gas valve (13), so that gas under pressure can be forced through said at least one gas passage opening (10), separately from the beverage. Further, the connecting element (4) as described above comprises a first collar (4a) and a second collar (4b), whereby between the first collar (4a) and a second collar (4b) a recess (19) with a recess bottom (20) into a circular positioning means (11) is engaged. Further, the second collar (4b) of the connecting element (4) has a through going hole in the center to which the dispensing element (3) is lead through.

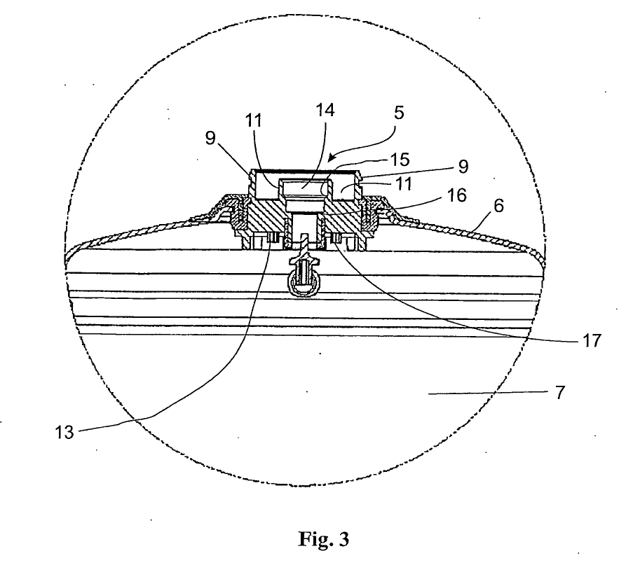

In the drawing FIG. 3 shows in sectional side elevation a beverage valve assembly (5) according to the present invention arranged on a container (6) in which an inner bag (7) is provided for receiving beverage, such as beer. The beverage valve assembly (5) is on the side facing the inner bag (7) provided with a gas passage opening (10) not shown to the inner space of the bag (7) and on the opposite side is surrounded by an outer standing up apron (9) which is gas-tight, while along the inner side wall of said apron, which functions as a first sealing surface and at a distance there from, an inner circular positioning means is arranged (11), while between said apron (9) and said positioning means (11) a bottom wall (12) with at least one gas valve (13) and at least one CO₂-valve (17) is provided which during operation is in communication with the space enclosed between the inner bag and the container surrounding the inner bag over a gas passage, a tubular part (14) for receiving a dispensing element (3) is arranged in the center, surrounded by the standing up positioning means (13), whereby said inner tubular part (14) comprises a second sealing surface (15) and a third sealing surface (16).

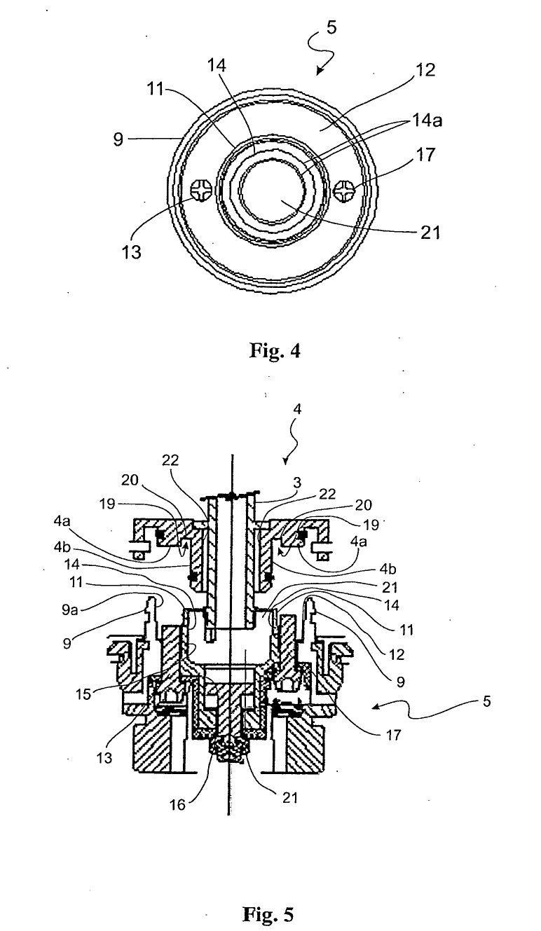

In the drawing FIG. 4 shows in a topside sectional side elevation a beverage valve assembly (5) with a bottom wall (12), a tubular part (14) extending downward from the bottom wall (12) and an outer circular apron (9) standing up from the bottom wall (12), wherein the tubular part (14) has a top opening (21) to receive a dispensing element (3), whereby the top opening (21) is preferably arranged in the middle section of the upper outer surface of the bottom wall (12), and the tubular part (14) has an upper inner tubular wall section with at least one sealing surface, whereby an upper section of the inner tubular part is step-like and/or shoulder-like shaped (14a) not shown, the outer standing up apron (9) is arranged at a distance from the top opening (21) of the tubular part (14), whereby the bottom wall (12) comprises gas-valve (13) and a CO₂-valve (17) positioned between the top opening (21) of the tubular part (14) and an inner side wall section of the outer standing up apron (9) and, whereby a circular positioning means (11) surrounds the top opening (21).

In the drawing FIG. 5 show in a sectional side elevation a beverage valve assembly (5) and a connecting element (4) according to the present invention before joint to each other. The beverage valve assembly (5) has a bottom wall (12), a tubular part (14) extending downward from the bottom wall (12) and an outer circular apron (9) standing up from the bottom wall (12), wherein the tubular part (14) has a top opening (21) to receive a dispensing element (3), whereby the top opening (21) is preferably arranged in the middle section of the upper outer surface of the bottom wall (12), and the tubular part (14) has an upper inner tubular wall section with a second sealing surface (15) and third sealing surface (16), the outer circular standing up apron (9) with a first sealing surface (9a) is arranged at a distance from the top opening (21) of the tubular part (14), whereby the bottom wall (12) comprises gas-valve (13) and a CO₂-valve (17) positioned between the top opening (21) of the tubular part (14) and an inner side wall section of the outer standing up apron (9) and, whereby the circular positioning means (11) surrounds the top opening (21). The connecting element (4) as described above comprises a first collar (4a) and a second collar (4b) with a through going hole (22) in the center to which the dispensing element (3) is lead through, whereby between the first collar (4a) and a second collar (4b) a recess (19) with a recess bottom (20) is formed into which a circular positioning means (11) can engage.

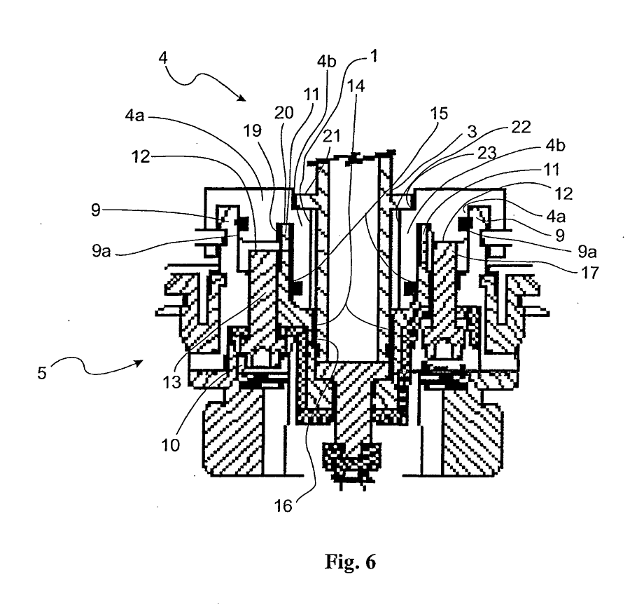

In the drawing FIG. 6 shows in a sectional side elevation a beverage valve assembly (5) and a connecting element (4) according to the present invention joint to each other. The beverage valve assembly (5) according to the present invention is arranged on a container (6) in which an inner bag (7) is provided for receiving beverage (not shown), such as beer. The beverage valve assembly (5) is on the side facing the inner bag (7) provided with a gas passage opening (10) to the inner space of the bag (7) and on the opposite side is surrounded by an outer standing up apron (9) which is gas-tight, while along the inner side wall (9a) of said apron (9), which functions as a first sealing surface (9a) and at a distance there from, an inner circular positioning (11) means is arranged, while between said apron (9) and said positioning means (11) a bottom wall (12) with a gas valve (13) and a CO₂-valve (17) are arranged, the gas valve (13) is during operation in communication with the space enclosed between the inner bag (7) and the container (8) surrounding the inner bag over a gas passage (10), a tubular part (14) for receiving a dispensing element (3) is arranged in the center of the beverage valve assembly (5), surrounded by the standing up positioning means (11), whereby said inner tubular part (14) comprises a second sealing surface (15) and a third sealing surface (16). The valve assembly (5) being assembled such that during operation a first collar (4a) of a connecting element (4) abuts gas-tightly and liquid-tightly against the first sealing surface (9a) of the inner side of said apron (9) and a second collar (4b) of said connecting element (4) with a through going hole (22) in the center to which the dispensing element (3) is lead through abuts gas-tightly and liquid-tightly against the second sealing surface (15) of the tubular part (14), while a dispensing element (3) abuts gas-tightly and liquid-tightly against the third sealing surface (16) of the inner tubular part (14), whereby the connecting element (4) is positioned in such a way that the gas passage opening (18) not shown of the first collar (4a) is in communication with the gas valve (13), so that gas under pressure can be forced through said at least one gas passage opening (10), separately from the beverage. Further, the connecting element (4) as described above comprises a first collar (4a) and a second collar (4b) with a through going hole (22) in the center to which the dispensing element (3) is lead through, whereby between the first collar (4a) and a second collar (4b) a recess (19) with a recess bottom (20) is formed into which a circular positioning means (11) is engaged. The second collar (4b) with the through going hole (22) possesses on its upper top section a step (23) to hold the dispensing element (3).

A sixth object of the present invention is directed to method for dispensing beer from a beverage tapping apparatus.

The method for dispensing beer from a beverage tapping apparatus comprises the steps, wherein after fitting the connecting element according to the present invention to a beverage valve assembly according to the present invention arranged on a container with an inner bag containing the beverage, the container is placed into a tapping apparatus, preferably with a chiller plate, and subsequently a gas is introduced through at least one gas passage opening between the inner bag and the surrounding container for compressing the inner bag, thereby displacing the beverage present in the inner bag, upon opening of the beverage valve.

1. A beverage valve assembly (5), comprising:
a bottom wall section (12);
a tubular part (14) extending downward from the bottom wall section (12);
an outer apron (9) standing up from the bottom wall section (12); wherein the tubular part (14) has a top opening (21) to receive a dispensing element (3), whereby the top opening (21) is preferably arranged in the middle section of the upper outer surface of the bottom wall (12), and the tubular part (14) has an upper inner tubular wall section with at least one sealing surface (15, 16), the outer standing up apron (9) is arranged at a distance from the top opening (21) of the tubular part (14), whereby the bottom wall (12) section comprises at least one valve positioned between the top opening (21) of the tubular part (14) and an inner side wall section of the outer standing up apron (9).

2. A beverage valve assembly (5) according to claim 1, wherein along the inner side wall section of said apron (9) and at a distance there from at least one positioning means (11) is arranged, whereby at least one positioning means (11) is preferably a standing up wall, more preferably at least one positioning means (11) is a standing up wall surrounding the top opening (21) of the tubular part (14).

3. A beverage valve assembly (5) according to claim 1 wherein the inner side wall section of said apron (9) functions as a first sealing surface (9a) so that a connecting element (4) is able to abut gas-tightly and liquid-tightly against the first sealing surface (9a) of the inner side wall section of said apron (9).

4. A beverage valve assembly (5) according to claim 1 wherein the apron (9) and at least one positioning means (11) are arranged concentrically with respect to the top opening (21).

5. A beverage valve assembly (5) according to claim 1 wherein the inner tubular wall section is annularly shaped and comprises a first step or first shoulder (14a), whereby the upper outer surface of said first step or first shoulder (14a) is arranged equal, is arranged above or is arranged below to the upper outer surface of the bottom wall section (12), preferably the inner tubular wall section of said upper tubular part (14) has at least a first step or first shoulder (14a) and a second step or second shoulder (14b), preferably the second step or second shoulder (14a) is annularly shaped, whereby the second step or second shoulder (14a) is arranged below the first step or first shoulder (14a), and preferably the diameter of the opening (21) of the tubular within the annularly shaped first step or first shoulder (14a) is substantially larger than the diameter of the opening (21) of the tubular part (14) within the annularly shaped second step or second shoulder (14a).

6. A beverage valve assembly (5) according to claim 5 wherein inside the tubular part (14), preferably below the second step or second shoulder (14a), a beverage valve is arranged.

7. A beverage valve assembly (5) according to claim 1 whereby the bottom wall (12) comprises two valves, preferably one valve is connected to the passage to the space between the keg and the bag and one is connected to the passage to the inner part of the bag, more preferably the valve connected to the passage to the space between the keg and the bag is an air valve and/or the valve connected to the passage to the inner part of the bag is a CO₂-valve (17), preferably the valves are spaced radially out at the same circle-normal at an equal distance of each other from the center point and are arranged in the bottom wall section (12) between the inner wall section of said outer apron (9) and the opening (21) of the tubular part (14) or within the bottom wall section (12) between the inner wall section (9a) of said outer apron (9) and the outer wall section of said inner positioning means (11).

8. A beverage valve assembly (5) according to claim 1 whereby the internal diameter of the standing up apron (9) is 10 mm to 100 mm, preferably 20 mm to 60 mm and more preferably 30 mm to 50 mm; and the height of the apron (9) measured from the upper outer surface of the bottom adjacent to the apron (9) is 0.5 mm to 50 mm, preferably 3 mm to 30 mm and more preferably 5 mm to 25 mm; and the thickness of the apron (9) is 0.1 mm to 15 mm, preferably 0.5 mm to 10 mm and more preferably 1 mm to 5 mm.

9. A beverage valve assembly (5) accordingly to claim 1 whereby the internal diameter of the standing up positioning means (11) is 0.5 mm to 50 mm, preferably 5 mm to 30 mm and more preferably 10 mm to 25 mm; and the height of at least one positioning means (11) measured from the upper outer surface of the bottom adjacent to the apron (9) is 0.5 mm to 50 mm, preferably 3 mm to 30 mm and more preferably 5 mm to 25 mm; and the thickness of at least one positioning means (11) is 0.1 mm to 15 mm, preferably 0.5 mm to 10 mm and more preferably 1 mm to 5 mm.

10. A beverage valve assembly (5) according to claim 1 whereby the diameter of the top opening (21) of the apron (9) facing away from the bottom wall (12) is 0.5 mm to 50 mm, preferably 3 mm to 30 mm and more preferably 5 mm to 25 mm; and/or the diameter of the top opening (21) of at least one positioning means (11) facing away from the bottom wall (12) is 0.5 mm to 50 mm, preferably 3 mm to 30 mm and more preferably 5 mm to 25 mm.

11. A beverage valve assembly (5) according to claim 5 whereby the internal diameter of the top opening (21) of the tubular part (14) and/or the diameter of the opening (21) within the annularly shaped first step or first shoulder (14a) of the tubular part (14) is 0.5 mm to 50 mm, preferably 3 mm to 30 mm and more preferably 5 mm to 25 mm; and/or the diameter of the opening (21) within the annularly shaped second step or second shoulder (14a) of the tubular part (14) is 0.5 mm to 50 mm, preferably 3 mm to 30 mm and more preferably 5 mm to 25 mm.

12. A beverage valve assembly (5) according to claim 5 whereby the width of the upper outer surface of the annularly formed first step or first shoulder (14a) is 0.5 mm to 50 mm, preferably 3 mm to 30 mm and more preferably 5 mm to 25 mm; and/or the width of the upper outer surface of the annularly formed second step or second shoulder (14a) is 0.5 mm to 50 mm, preferably 3 mm to 30 mm and more preferably 5 mm to 25 mm.

13. A beverage valve assembly (5) according to claim 5 whereby the altitude difference between the upper outer surface of the annularly formed first step or first shoulder (14a) to the upper outer surface of the annularly formed second step or second shoulder (14a) is 0.1 mm to 50 mm, preferably 1 mm to 25 mm and more preferably 2 mm to 20 mm.

14. A connecting element (4) for engaging to a beverage valve assembly (5) in order to provide a separate gas and beverage passage, whereby the connecting element (4) comprises a first outer collar (4a) and a second inner collar (4b), whereby the first outer collar (4a) has at least one gas passage opening (18) and the second inner collar (4b) has a through going hole (22) for receiving a dispensing element (3), whereby the first outer collar (4a) and the second inner collar (4b) are arranged, preferably concentrically, at a distance from each other and whereby between the first outer collar (4a) and the second inner collar (4b) a recess (19) is formed.

15. A connecting element (4) according to claim 14 for engaging with a beverage valve assembly (5).

16. A connecting element (4) according to claim 14 wherein the second inner collar is higher than the first outer collar.

17. A connecting element (4) according to claim 14 whereby the first outer collar has at its upper outer surface, preferably at or near to the outer edge of its upper outer surface, at least one flexible sealing means; and/or the second inner collar has at its upper outer surface, preferably at or near to the outer edge of its upper outer surface, at least one flexible sealing means, more preferred the flexible sealing means is an o-ring.

18. A connecting element (4) according to claim 14 whereby the internal diameter of the first outer collar is 1 mm to 100 mm, preferably 20 mm to 60 mm and more preferably 30 mm to 50 mm; and the height of the first outer collar as measured from the bottom (20) of the recess (19) adjacent to the first outer collar is 0 mm to 50 mm, preferably 5 mm to 30 mm and more preferably 10 mm to 25 mm; and the thickness of the first outer collar is 0.1 mm to 30 mm, preferably 1 mm to 20 mm and more preferably 2 mm to 15 mm.

19. A connecting element (4) according to claim 14 whereby the internal diameter of the second inner collar is 0.1 mm to 50 mm, preferably 2 mm to 35 mm and more preferably 5 mm to 25 mm; and the height of the second inner collar as measured from the bottom (20) of the recess (19) adjacent to the second inner collar is 0 mm to 50 mm, preferably 2 mm to 40 mm and more preferably 5 mm to 30 mm; and the thickness of the second inner collar is 0.1 mm to 15 mm, preferably 0.2 mm to 10 mm and more preferably 0.5 mm to 5 mm.

20. A connecting element (4) according to claim 14, whereby the internal diameter of the top opening of the first inner collar (4a) facing to the beverage valve assembly (5) is 0.1 mm to 50 mm, preferably 2 mm to 35 mm and more preferably 5 mm to 25 mm; and/or the internal diameter of the top opening (22) of the second inner collar facing to the beverage valve assembly (5) is 0.1 mm to 50 mm, preferably 2 mm to 35 mm and more preferably 5 mm to 25 mm.

21. A connecting element (4) according to claim 14 whereby the distance of the inner side wall of the first collar (4a) to the outer side wall of the second collar (4b) is 0.5 mm to 50 mm, preferably 2 mm to 20 mm and more preferably 5 mm to 15 mm.

22. A tapping device (2) comprising a connecting element (4) according to claim 14

23. A tapping device (2) according to claim 22, whereby it is provided with means for operation of a beverage valve assembly (5) to which a container (6) is receivable engaged.

24. A tapping device (2) according to claim 22 whereby the through going hole (22) of the second inner collar (21) receivable contains a tubular dispensing element (3) of a cartridge unit for a beverage dispensing system with an inner channel for the dispensation of a beverage, whereby that cartridge unit comprises preferably a first part facing to the container (6), which is made out of a rigid material and a second part faces in the opposite direction, which is made out of a flexible material.

25. A tapping device (2) according to claim 24, whereby the tubular dispensing element (3) of the cartridge unit is higher than the second inner collar, preferably the tubular dispensing element (3) of the cartridge unit extends over the inner upper edge of the through going hole (22) of the second collar (4b) facing to the beverage valve assembly (5) with a height of ≧0 mm to 100 mm, preferably 5 mm to 60 mm and more preferably 20 mm to 50 mm.

26. A beverage valve assembly (5) arranged at a container (6) in which an inner bag (7) is provided for receiving beverage, in particular carbonated beverage such as beer, wherein a beverage valve assembly (5) is provided according to claim 1

27. A beverage valve assembly (5) arranged at a container (6) according to claim 26, to which during operation a connecting element (4) or a tapping device (2) is arranged at the beverage valve assembly (5).

28. A beverage valve assembly (5) according to claim 27 wherein during operation a first collar (4a) of the connecting element (4) abuts gas-tightly and liquid-tightly against the first sealing surface (9a) of the inner side of said apron (9), and/or a second collar (4b) of said connecting element (4) abuts gas-tightly and liquid-tightly against the second sealing surface (15) of the tubular part (14), and/or a dispensing element (3) abuts gas-tightly and liquid-tightly against the third sealing surface (16) of the inner tubular part (14).

29. A beverage valve assembly (5) arranged at a container (6) according to claim 27 which on the side facing the inner bag (7) is provided with a gas passage opening (10) to the inner space of the bag and on the opposite side is surrounded by an outer standing up apron (9) which is gas-tight, while along the inner side wall of said apron (9), which functions as a first sealing surface (9a) and at a distance there from, an inner positioning means (11) is arranged, while between said apron (9) and said positioning means (11) a bottom wall (12) with at least one gas valve (13) is provided which during operation is in communication with the space enclosed between the inner bag (7) and the container (6) surrounding the inner bag (7) over a gas passage, a tubular part (14) for receiving a dispensing element (3) is arranged in the center, optionally surrounded by a standing up positioning means (11), whereby said inner tubular part (14) comprises a second sealing surface (15) and a third sealing surface (16), the valve assembly being such that during operation a first collar (4a) of a connecting element (4) abuts gas-tightly and liquid-tightly against the first sealing surface (9a) of the inner side of said apron (9) and a second collar (4b) of said connecting element (4) abuts gas-tightly and liquid-tightly against the second sealing surface (15) of the tubular part (14), while a dispensing element (3) abuts gas-tightly and liquid-tightly against the third sealing surface (16) of the inner tubular part (14), whereby the connecting element (4) is positioned in such a way that the gas passage opening (18) of the first collar (4a) is in communication with the gas valve (13), so that gas under pressure can be forced through said at least one gas passage opening (10), separately from the beverage.

30. A beverage tapping apparatus (1) comprising a replaceable container (6) with a beverage valve assembly (5) according to claim 27 receivable engaged to a connecting element (4) of a tapping device (2), whereby the beverage valve assembly (5) on the side facing the inner bag (7) is provided with a gas passage opening (10) to the inner space of the bag and on the opposite side is surrounded by an outer standing up apron (9) which is gas-tight, while along the inner side wall of said apron (9), which functions as a first sealing surface (9a) and at a distance there from, an inner positioning means (11) is arranged, while between said apron (9) and said positioning means (11) a bottom wall (12) with at least one gas valve (13) is provided which during operation is in communication with the space enclosed between the inner bag (7) and the container (6) surrounding the inner bag (7) over a gas passage, a tubular part (14) for receiving a dispensing element (3) is arranged in the center, optionally surrounded by a standing up positioning means (11), whereby said inner tubular part (14) comprises a second sealing surface (15) and a third sealing surface (16), the valve assembly being such that during operation a first collar (4a) of a connecting element (4) abuts gas-tightly and liquid-tightly against the first sealing surface (9a) of the inner side of said apron (9) and a second collar (4b) of said connecting element (4) abuts gas-tightly and liquid-tightly against the second sealing surface (15) of the tubular part (14), while a dispensing element (3) abuts gas-tightly and liquid-tightly against the third sealing surface (16) of the inner tubular part (14), whereby the connecting element (4) is positioned so that the gas passage opening (18) of the first collar (4a) is in communication with the gas valve (13), so that gas under pressure can be forced through said at least one gas passage opening, (10) separately from the beverage.

31. A method for dispensing beer from a beverage tapping apparatus (1), wherein after fitting the connecting element (4) according to claim 14 to a beverage valve assembly (5) of a container (6) with an inner bag (7) comprising the beverage, the container (6) is placed into a tapping apparatus and subsequently a gas is introduced through at least one gas passage opening (10) between the inner bag (7) and the surrounding container (6) for compressing the inner bag (7), thereby displacing the beverage present in the inner bag (7), upon opening of the beverage valve.
